(19) United States
(12) Patent Application Publication
(10) Pub. No.: US 2026/0188102 A1
(43) Pub. Date: Jul. 2, 2026

(54) Method for alerting a remote communication terminal and associated alert communication device

(71) Applicant: ORANGE, ISSY-LES-MOULINEAUX (FR)

(72) Inventors: Thierry MARTINEZ, CHATILLON CEDEX (FR); Christian GREGOIRE, CHATILLON CEDEX (FR); Régis ESNAULT, CHATILLON CEDEX (FR)

(21) Appl. No.: 19/113,649

(22) PCT Filed: Sep. 26, 2023
(86) PCT No.: PCT/EP2023/076458

§ 371 Date: Mar. 20, 2025

(30) Foreign Application Priority Data
Sep. 28, 2022 (FR) 2209854

(51) Int. Cl. G08B 25/01

(52) U.S. Cl. CPC G08B 25/016

(57) ABSTRACT

An alert method implemented by an alert communication device. The method includes establishing a communication session between the alert communication device and a remote communication terminal triggered by a detection of an alert situation; and transmitting, via the established communication session, a generated message.

### CROSS-REFERENCE TO RELATED APPLICATIONS

This Application is a Section 371 National Stage Application of International Application No. PCT/EP2023/076458, filed Sep. 26, 2023, and published as WO 2024/068581 A1 on Apr. 4, 2024, not in English, which claims priority to and the benefit of French Patent Application No. 2209854, filed Sep. 28, 2022, the contents of which are incorporated herein by reference in their entireties.

### TECHNICAL FIELD

The present invention belongs to the general field of communication, and more specifically to teleassistance. It more particularly relates to an alert method for a remote communication terminal. It also relates to an alert communication device for a remote communication terminal configured to implement such a method.

### DISCUSSION OF RELATED TECHNOLOGY

The teleassistance systems currently deployed consist of a box installed in a person's home and coupled to a radio emitter in the form of a medallion or a bracelet to be worn permanently by the person. In the event of a fall or any other emergency, the person presses a button on the radio emitter to initiate an emergency call. Pressing the emergency button generates the sending of a radio signal (e.g., Wi-Fi, Bluetooth) to the box which in turn triggers the call to a teleassistance call center.

The person can then communicate with an interlocutor from the teleassistance call processing center by means of a microphone and of a speaker on the box to explain the reason for the call. If the interlocutor considers that the person is in an emergency situation, they immediately alert the person's relatives or possibly the emergency services so that they can intervene at the person's home.

Another teleassistance solution consists of a connected bracelet comprising a SIM card. This connected bracelet is configured to geolocate the person, measure the blood pressure and/or the heart rate and manually alert an interlocutor of a danger or a fall by means of an emergency button.

There are also solutions to ensure the protection and safety of isolated workers. These devices, sometimes called “isolated worker alarm devices”, can be triggered when specific situations, such as loss of verticality or absence of movement, are detected by said device. In this case, a call to a call center is then made.

However, such solutions do not offer the possibility of transmitting data to the interlocutor of the call processing center without it being necessary for them to use an interpreter, that is to say without it being necessary for the interlocutor to use a computer tool configured to analyze and translate data written in a computer language and transmitted by one of the teleassistance devices previously mentioned to the call center.

### SUMMARY

The disclosed technology aims to overcome all or part of the drawbacks of the prior art, in particular those set out above, by proposing a solution which, in response to the detection of an alert situation, makes it possible to communicate with the interlocutor of a call center, and in particular to inform them of the context of the call and, where appropriate, of the evolution of the situation.

To this end, and according to a first aspect, the disclosed technology relates to an alert method for a remote communication terminal, the method being implemented by an alert communication device (100) and comprising:
an establishment of a communication session between said alert communication device and a remote communication terminal triggered by a detection of an alert situation; and,
a transmission, via the established communication session, of a generated message.

By message it is meant not a compilation/aggregation of acquired raw data generally in machine language(s) but a message readable by a human, in particular a message in natural language, or another writing method readable by a human such as stenography.

Thus, the alert communication device is able to communicate in natural language with an interlocutor of a remote communication terminal such as a relative via their mobile phone, an interlocutor from an alert or even an emergency service, etc. This proves particularly advantageous when an individual in an alert situation is unable to dialog with this interlocutor, in particular when the individual is unconscious or having a coughing fit or choking, etc.

Furthermore, the opening of a communication session by the alert communication device allows an exchange between the interlocutor of the remote communication terminal, particularly allows the interlocutor to request additional information and/or to ask questions to the alert communication device which can always respond in the same communication session.

Generally, it is considered that the steps of a method should not be interpreted as being related to a notion of temporal succession.

In particular modes of implementation, the alert method may further include one or more of the following characteristics, taken separately or in all technically possible combinations.

In particular modes of implementation, the establishment of the communication session is triggered by the detection of an alert situation based on data acquired from at least one sensor.

Thus, based on data acquired from at least one sensor, an alert situation is detected and it is this alert situation detection that triggers the establishment of the communication session. The communication session is therefore established when an alert situation is detected, in particular by means of data acquired from connected objects present in an environment and/or on an individual.

In particular modes of implementation, the transmission emits a message generated based on the detected alert situation and on data acquired from at least one sensor.

Thus, the message transmitted via the communication session is not a simple notification of the alert situation but includes data acquired from connected objects present in an environment and/or on an individual allowing the user of the remote communication terminal and/or a remote decision device to make decisions relating to the alert situation, in particular in terms of deployment of emergency services, access to the environment and/or the individual in the alert situation, etc. It should be noted that the message generated is based on acquired data that may either include all or part of the acquired data based on which the alert situation is detected, or be distinct from the acquired data based on which the alert situation is detected.

In particular modes of implementation, the transmitted message is a voice message generated by voice synthesis based on data acquired from at least one sensor.

In particular modes of implementation, the method further comprises:
an acquisition of data from at least one sensor, the acquired data being at least one data among the following:
   data relating to a first individual;
   data relating to an environment;
   data relating to an environment of a first individual;
   data captured by at least one sensor connected to the alert communication device;
   data captured by at least one sensor of the alert communication device;
   sound data including at least one sound signal captured by at least one sensor connected to the alert communication device;
   sound data including at least one sound signal captured by at least one sensor of the alert communication device.

In particular modes of implementation, the method further comprises:
a detection of an alert situation by analysis of the data acquired from at least one sensor, the detection triggering the establishment of the communication session if an alert situation is detected.

In particular modes of implementation, a detection of an alert situation is performed by analysis of sound data acquired from at least one sensor.

These sound data are for example:
an instruction from the first individual to establish communication;
sound data making it possible to determine the inability of the first individual to establish a communication and/or even to communicate, such as a cough, a rattle, a choking, etc.
environmental sound data making it possible to determine an emergency situation such as a crash, a crackle, etc. regardless of the presence or absence of a first individual.

In particular modes of implementation, the method further comprises the calculation of a value representative of a probability that the individual is unable to contact an emergency service, the establishment of a communication session being implemented if said value is greater than a threshold value.

In particular modes of implementation, the method further comprises a determination of the remote communication terminal based on the detected alert situation.

In particular modes of implementation, the method further comprises:
a generation of an alert message, called first message, based on at least one data among at least the following data:
   at least one data acquired;
   at least one data provided by analysis of data acquired from at least one sensor, and the alert message is able to be vocally synthesized and transmitted, upon establishment of the communication session, in the form of a voice message via the established communication session.

In particular modes of implementation, the method further comprises:
an activation of an audio sensor, the audio sensor being an audio sensor among the following:
   an audio sensor of said alert communication device;
   an audio sensor connected to the alert communication device;
the activation being triggered based on at least one data among the following:
   at least one data acquired from at least one sensor;
   at least one data provided by analysis of data acquired from at least one sensor;
   at least one piece of information extracted, by voice recognition, from a second voice message coming from the remote communication terminal with which the communication session is established.

The at least one data and at least one data provided by analysis of acquired data are advantageous since they allow:
determining that the first individual is able to communicate even if they were not able to contact the emergency services;
determining that the first individual has regained their ability to communicate;
being used by the interlocutor to complete the analysis of the situation provided in the form of voice message(s) by the alert method;
or even determining the presence of a second individual in the vicinity of the first individual able to communicate with the interlocutor.

In particular modes of implementation, the method further comprises:
a voice synthesis of a message consisting of at least one piece of information among the following:
   at least one data acquired;
   at least one data provided by analysis of data acquired from at least one sensor;
   at least one piece of information extracted, by voice recognition, from a voice signal coming from a device, the signal being one among the following:
      a second voice message coming from the remote communication terminal with which the communication session is established;
      a voice signal from a local audio sensor activated by the alert method;
   at least one alert message, called first message, generated based on one piece of information among the previous ones;
   at least one response message, called third message, generated based on one piece of information among the previous ones, the response message resulting from the second voice message coming from the remote communication terminal.

In particular modes of implementation, the method further comprises:
a voice recognition extracting information from a voice signal coming from a device, the voice signal being one among the following:
   a second voice message coming from the remote communication terminal with which the communication session is established;
   a voice signal from a local audio sensor activated by the alert method.

In particular modes of implementation, the method further comprises:
a control of an actuator by means of a command generated based on at least one element among the following:
   an alert situation detected;
   at least one data acquired;
   at least one data provided by analysis of data acquired from at least one sensor;
   at least one piece of information extracted, by voice recognition, from a second voice message coming from one device among the following:
      the remote communication terminal with which the communication session is established;
      an audio sensor connected to the alert communication device and activated by the alert method.

Each of these different particular modes of implementation can be implemented alone or in combination with one or more of the particular modes of implementation of the disclosed technology.

According to a second aspect, the disclosed technology relates to a computer program including instructions for the implementation of an alert method, when said program is executed by a processor.

According to a third aspect, the disclosed technology relates to a recording medium readable by a computer on which the computer program according to the disclosed technology is recorded.

According to a fourth aspect, the disclosed technology relates to an alert communication device able to communicate with a remote communication terminal and comprising:
a communication interface, the communication interface being able to:
   establish a communication session between said communication device and a remote communication terminal as soon as an alert situation is detected,
   transmit, via the established communication session, a first voice message generated by voice synthesis.

In particular modes of implementation, the communication interface includes an emitter for transmitting (e.g., emitting) the generated voice message.

In particular modes of implementation, the communication interface further comprises a receiver able to receive voice messages coming from the remote communication terminal.

In particular modes of implementation, the alert communication device further comprises means for keeping traces of the exchanges and/or actions performed, for possible subsequent analysis of the situation.

In particular modes of implementation, the alert communication device further comprises:
a module for acquiring data from at least one sensor, the acquired data are data among the following:
   data relating to a first individual;
   data relating to an environment;
   data relating to an environment of a first individual;
   data captured by at least one sensor connected to the device.

In particular modes of implementation, the alert communication device further comprises:
a detector of an alert situation able to perform an alert situation detection by analysis of data acquired from at least one sensor.

In particular modes of implementation, the alert communication device further comprises:
a voice synthesizer of a first message generated based on at least one piece of information among the following:
   at least one data acquired from at least one sensor;
   at least one data provided by analysis of data acquired from at least one sensor;
   at least one piece of information extracted, by voice recognition, from a first voice message coming from a device among the following:
      the remote communication terminal with which the communication session is established;
      a local audio sensor activated by the alert method;
   at least one first alert message generated based on one piece of information among the previous ones.

According to a fifth aspect, the disclosed technology relates to a communication terminal able to communicate with a remote communication terminal and comprising:
a communication interface, the communication interface being able to:
   establish a communication session between said communication device and a remote communication terminal as soon as an alert situation is detected,
   transmit via the established communication session a first voice message generated by voice synthesis.

In particular modes of implementation, the communication interface includes an emitter for transmitting (e.g., emitting) the generated voice message.

In particular modes of implementation, the communication interface further comprises a receiver able to receive voice messages coming from the remote communication terminal.

In particular modes of implementation, the communication terminal includes either a processor executing the steps of the alert method according to the disclosed technology, or the alert communication device according to the disclosed technology.

### BRIEF DESCRIPTION OF THE DRAWINGS

Other characteristics and advantages of the disclosed technology will emerge from the description given below, with reference to the appended drawings which illustrate one exemplary mode of implementation thereof without any limitation. In the figures:

FIG. 1 represents, in the form of a simplified block diagram, one example of an alert method for a remote communication terminal, as implemented by the alert communication device of FIG. 3 or FIG. 4;

FIG. 2A represents, in the form of a simplified block diagram, one example of an alert method for a remote communication terminal, proposing a more detailed mode of implementation relative to the establishment of the communication session and the transmission of the first message to the communication terminal;

FIG. 2B represents, in the form of a simplified block diagram, one example of an alert method for a remote communication terminal, proposing a more detailed mode of implementation relative to a connection between the interlocutor of the remote communication terminal and at least one second individual on the alert site (in particular in the vicinity of a first individual);

FIG. 2C represents, in the form of a simplified block diagram, one example of detection of an alert situation used and/or implemented by the alert method for a remote communication terminal;

FIG. 3 schematically represents one exemplary mode of implementation, in accordance with the disclosed technology, of an alert communication device able to communicate with a remote communication terminal;

FIG. 4 schematically represents one example of hardware architecture of an alert communication device able to communicate with a remote communication terminal;

FIG. 5 schematically represents a first use case in accordance with the disclosed technology, in which a system comprises an alert communication device able to communicate with a remote communication terminal, in particular an alert service, or even an emergency service; and,

FIG. 6 schematically represents a second use case in accordance with the disclosed technology, in which a system comprises an alert communication device able to communicate with a remote communication terminal, in particular an emergency service.

### DESCRIPTION

By alert situation it is meant any situation requiring external intervention, whether it is an alert situation relating to an individual requiring the intervention of either a contact person such as a friend, a family member, more generally a relative (for example following a fall) or a specially mandated personal assistance service (health care aid, nurse, etc.) or an emergency service (firemen, SAMU (the French emergency medical services), police, etc.), or an alert situation relating to an empty environment (i.e. in the absence of any individual), etc.

It should be noted that the figures below are described in a use case where a first individual is in the alert situation. However, the disclosed technology can be used when several first individuals are in the same alert situation: for example, a damaged vehicle with several first individuals on board, a passenger compartment (house, boat) in an alert situation such as a fire, a grounding, etc. with several first individuals inside, etc. or when the environment of the alert situation does not include anyone (no first individual) upon detection of an alert situation: detection of intrusion, fire, flooding, etc. in the absence of residents.

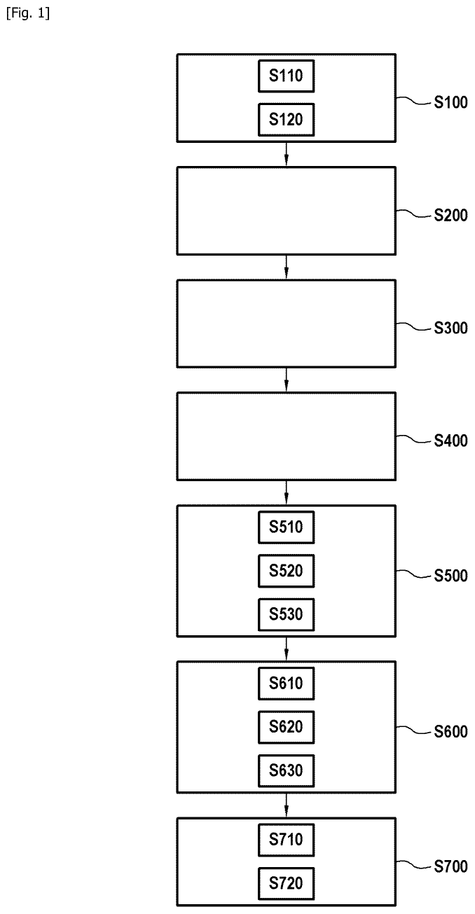

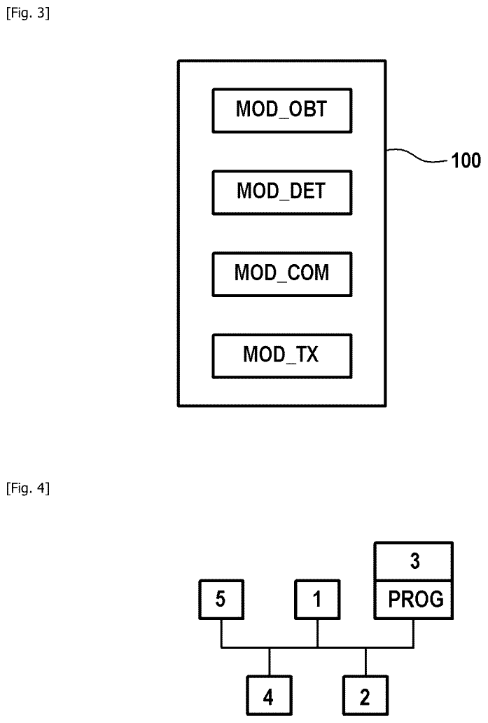

FIG. 1 represents, in simplified block diagram form, one example of an alert method for a remote communication terminal, as implemented by the alert communication device 100 illustrated by way of example in FIG. 3 or FIG. 4.

Particularly, upon data acquisition S100, the alert communication device 100 acquires (S110) in particular data relating to a first individual such as health data of the first individual and/or acquires (S120) data relating to an environment, in particular to the environment of the first individual when a first individual is present in the environment in which an alert situation is evaluated. The data acquired from at least one sensor are, for example, data among the following:
data relating to a first individual;
data relating to an environment;
data relating to an environment of a first individual;
data captured by at least one sensor connected to the device.

This step is in particular implemented by the data acquisition module, also called data acquisition module MOD_OBT, from the alert communication device 100. By data acquisition module it is meant in particular one or more of the devices among the following: a data receiver, a data reader, a data sensor of the alert communication device.

The data acquired from at least one sensor are in particular:
data captured by one or more sensor(s) of a local area network 160 connected to said alert communication device 100 via a wired or non-wired connection and received by the alert communication device 100 coming from the sensor(s) via the local area network 160,
or even data captured by one or more sensor(s) of said alert communication device 100.

By health data of a first individual it is particularly meant physiological data such as blood pressure, respiratory rate, heart rate and/or temperature, blood sugar level, and/or data relating to an evolution in the position of the first individual such as loss of verticality (or fall) or the absence of movement for a predetermined period, etc.

The health data are collected by various sensors, called health sensors, before being, where appropriate, transmitted regularly to the alert communication device 100. These health sensors for example take the form of a bracelet, a connected watch or a connected clothing composed of a textile material capable of capturing and recording or reacting to a signal or a stimulus.

Alternatively or complementarily, the acquisition of a health data results from an action by the first individual, for example from pressing a button on a radio emitter such as a connected object, in the form of a bracelet or a medallion, or directly on a button of the alert communication device (for example when it is implemented in a mobile phone) so that the alert communication device 100 is informed that this first individual is in an alert situation, in particular that the first individual has just fallen.

By data relating to the environment, it is meant the type of environment in which the alert communication device 100 is present or even installed (e.g., whether it is a home, a means of transport, etc.), the location of the latter (e.g., its address and/or its geographical coordinates), the energy sources of the environment (gas and/or electricity inlet, presence of an electric generator (e.g., battery), etc.), but also data captured (smoke, fire, breakdown, intrusion detection, etc.), in particular sound data captured, by one or more monitoring sensor(s):
either from a local area network 160 connected to said alert communication device 100 via a wired or non-wired connection and received by the alert communication device 100 coming from the sensor(s) via the local area network 160,
or from said alert communication device 100 in the environment.

Particularly, the alert method comprises a detection S200 of an alert situation, in particular a determination that the first individual is in an alert situation. The alert situation detection S200 is in particular determined based on data acquired from at least one sensor, for example by analysis of data acquired and/or sound data acquired from at least one sensor, such as those mentioned above. Optionally, the detection S200 of an alert situation thus includes an analysis of the acquired data and/or of the acquired sound data providing an analysis result from which the alert situation is detected. The detection S200 is in particular implemented by the alert situation detector MOD_DET of the alert communication device 100.

In particular modes of implementation, the alert method or even the alert situation detection S200, particularly the analysis implemented by the alert situation detection, includes in particular a calculation of a value representative of a probability that the first individual is unable to contact a remote communication terminal, the calculation triggering the establishment (S300) of the communication session if said value is greater than a threshold value.

In particular modes of implementation, the analysis includes, in particular, an evaluation of one or more value(s) collected by at least one of the sensors, for example by comparison of the value collected by at least one of the sensors with a predetermined value, possibly stored in non-volatile memory 4 of the alert communication device 100.

In particular modes of implementation, the analysis comprises:
a combination (also called “fusion”) of several data coming from one or more different sensor(s) in order to generate a set of exploitable data.

The alert situation detection S200 is then performed, particularly, on the basis of this set of exploitable data. Particularly, the analysis includes:
an assessment of the situation on the basis of this set of exploitable data, in particular of the type of situation: alert situation, or even emergency situation, or not.

In particular modes of implementation, the alert method comprises a determination of the remote communication terminal based on the detected alert situation, in particular on the type of alert situation or the event that triggered the alert situation: fall, choking, heart problem, intrusion, smoke, etc.

In particular modes of implementation, the analysis comprises an interpretation of a signal transmitted by a radio emitter and received by the alert communication device 100, following a specific action by the individual, for example pressing a button on this emitter.

In particular modes of implementation,
the acquisition comprises a capture of sound signals by one or more audio sensor(s) of the alert communication device 100 or connected to the alert communication device 100,
and the analysis comprises a detection of a voice alert signal in the captured sound signals, in particular by detection, in a sound signal, of an instruction to establish a communication session of said alert communication device with a remote communication terminal, in particular a terminal of an alert service, or even a remote communication terminal, for example “Call the firemen”.

Alternatively or complementarily, the analysis comprises a detection in a captured sound signal of one or more distress signal(s), also called “noises characterizing a distress”. In this case, the analysis comprises for example a comparison of a signature of the sound signals with a plurality of signals characterizing the distress of an individual.

Alternatively or complementarily, a spectral analysis of the captured sound sample makes it possible to determine whether the first individual is actually in an alert situation, in particular an emergency situation, or not.

The alert method according to the disclosed technology includes a communication session establishment S300 between the alert communication device and a remote communication terminal triggered by a detection of an alert situation, in particular the alert situation detection S200, possibly based on data acquired from at least one sensor. Thus, if it is determined that the first individual is actually in an alert situation, the alert communication device 100 establishes communication with a remote communication terminal of a predetermined interlocutor such as a relative; an alert service, in particular a personal assistance service, a monitoring service, etc. ; an emergency service such as the firefighters, the police, etc. during the session establishment S300. This session establishment is in particular implemented by the communication interface MOD_COM, also called communication manager, of the alert communication device 100.

In particular modes of implementation, the analysis carried out during the alert situation detection S200 comprises the calculation of a value representative of a probability that the first individual is unable to contact a remote communication terminal, and the establishment S300 of a communication session is carried out if this value is greater than a threshold value. By “inability to contact a remote communication terminal” it is meant any inability to move, in particular to reach a communication terminal and/or the alert communication device and/or inability to vocally dialog with the interlocutor of the remote communication terminal, in particular inability to speak and/or inability to hear the interlocutor of the remote communication terminal and/or inability to respond to the interlocutor of the remote communication terminal (due to age, diminished mental capacity in particular by the alert situation, etc.).

Particularly, the alert method further comprises:
a determination of the remote communication terminal based on the detected alert situation.

In particular modes of implementation, the establishment of a communication session comprises a telephone call to a remote communication terminal, in particular to a communication terminal of a relative or of an alert service (pre-recorded number, for example), or even a communication terminal of an emergency service, for example by dialing 18, 112 or 196 for the firemen, 15 for the SAMU (the French emergency medical services), 17 for the police, etc. When the communication session through the telecommunications network 200 complies with the Session Initiation Protocol, the establishment of a communication session comprises for example the transmission of a request INVITE so that a proxy of the telecommunications network 200 receives the IP address from the recipient and relays a message, in particular an alert message also called a first message and, possibly one or more response message(s), also called second messages, coming from said alert communication device 100 to said recipient. Alternatively or complementarily, the establishment of a communication session comprises the opening of the channel 16 of the VHF marine band.

Particularly, the alert method further comprises a transmission via the established communication session of a generated message, in particular based on data acquired from at least one sensor. Optionally, at first, upon establishment of the communication session, the alert method transmits a first generated message, also called alert message, including, in part of the generated message, a piece of information relating to the detected alert situation that triggered the establishment of the communication session, and another part of the generated message based on data acquired from at least one sensor, this other part of the generated message being distinct from the part of information relating to the alert situation.

Particularly, the alert method further comprises:
a generation of an alert message, also called first message, based on at least one data among at least the following data:
   at least one data acquired from at least one sensor;
   at least one data provided by analysis of data acquired from at least one sensor,
and the alert message is able to be vocally synthesized and transmitted, upon establishment of the communication session, in the form of a voice message via the established communication session.

In particular modes of implementation, the first generated message includes a piece of information relating to the detected alert situation.

In particular modes of implementation, the first generated message includes a presentation information indicating to the interlocutor that they are in communication with a digital apparatus such as an alert voice assistant, a bot, etc. implemented by the alert communication device 100. Thus, the interlocutor knows the nature of the caller: an apparatus and not a human. The presentation is in particular short because it is not the object of the communication session.

Particularly, the method further comprises:
a voice synthesis S400 of a message constituted based on at least one piece of information among the following:
   at least one data acquired from at least one sensor;
   at least one data provided by analysis of data acquired from at least one sensor;
   at least one piece of information extracted, by voice recognition, from a voice signal coming from a device among the following:
      the second voice message from the remote communication terminal with which the communication session is established;
      a voice signal from a local audio sensor activated by the alert method;
   at least one alert message, called first message, generated based on one piece of information among the previous ones;
   at least one response message, called third message, generated based on one piece of information among the previous ones, the response message resulting from the second voice message coming from the remote communication terminal.

Particularly, the method further comprises a voice synthesis S400 of data derived from the analysis carried out during the detection S200, so as to allow the alert communication device 100 to communicate with an interlocutor of the emergency service. This voice synthesis is in particular implemented by a voice synthesizer MOD_TX of the alert communication device 100.

In particular modes of implementation, the alert method further comprises:
an activation (S720) of a local audio sensor, the local audio sensor being an audio sensor among the following:
an audio sensor of said alert communication device 100;
an audio sensor connected to the alert communication device 100;
the activation (S720) being triggered based on at least one data among the following:
   at least one data acquired from at least one sensor;
   at least one data provided by analysis of data acquired from at least one sensor;
   at least one piece of information extracted, by voice recognition, from a voice message coming from the remote communication terminal with which the communication session is established.

In the case of an activation triggered directly or indirectly by data acquired from at least one sensor, the data acquired make it possible, in particular, to detect that the sound of the alert situation may be decisive for the analysis made by the interlocutor (identifiable captured sound, conscious person, etc.), the sound signal captured following the activation of the audio sensor is transmitted in addition to the first message, also called alert message. For example, the first message is either superimposed on the captured sound then making up a background sound of the first message, or transmitted first and followed by the captured sound.

In the case of an activation triggered directly or indirectly by data acquired from at least one sensor, the data acquired make it possible, in particular, to detect the presence of a second individual in the vicinity of the first individual. Optionally, the detection of the presence of the second individual automatically triggers the activation of the audio sensor and/or of the speakers. Thus, the alert method reduces the number of calls to the same alert or emergency service, or avoids multiplying the alert or emergency services contacted since the second individual will be put in direct contact without using their own communication terminal.

Particularly, the alert method comprises in particular an activation of the audio sensor based on the type of alert situation and/or on the alert situation detection mode. Thus, when the alert situation establishes that the first individual is able to communicate even if they were unable to contact a remote communication terminal, the audio sensor or even the speakers of the alert communication device and/or connected to the alert communication device are automatically activated to allow the dialogue between the first individual and the interlocutor of the remote communication terminal. The alert method will use the data acquired from at least one sensor to supplement the elements provided by the first individual to the interlocutor or possibly to introduce the first individual thanks to the first message.

Particularly, the alert method further comprises:
a voice recognition extracting information from a voice signal coming from one among the following:
   the second voice message from the remote communication terminal with which the communication session is established;
   a voice signal from a local audio sensor activated by the alert method.

In particular modes of implementation, the interlocutor, who are not necessarily aware that they are dialoguing with an apparatus, particularly an alert communication device, interrogates this alert communication device 100 as to the reasons for the call and the circumstances of the alert situation in particular in order to determine the assistance procedure, in particular the emergency procedure, to be implemented. The alert communication device 100 is then configured to:
transcribe a voice message from the interlocutor, also called request message or instruction message or second message, into a second message exploitable by a message analyzer, in particular by voice recognition which transcribes the second voice message into a second text message and/or into useful data;
analyze the second transcribed message, the message analysis interprets the second transcribed message into one or more request(s), in particular one or more request(s) among the following:
   a request to parameterize an actuator to a given value;
   an action instruction;
   a request for information, data, etc.
   Thus, the message analysis allows the alert communication device to “understand” the meaning of the second voice message from the interlocutor, i.e. the request(s) of the interlocutor relating to the alert situation.
generate a response message, also called third message, based on the second transcribed message, in particular based on one or more response(s) to one or more request(s) from the second interpreted message; and,
vocally synthesize the third generated response message.

An inference engine implements in particular the message analysis and/or the response message generation. The message analysis and/or the response message generation is implemented for example using a request and/or response base possibly updated by learning and/or by a neural network and/or more generally by artificial intelligence, etc.

An inference engine possibly includes one or more of the following devices:
an analyzer interpreting the transcribed message,
an action instruction analyzer interpreting the action instruction interpreted from the transcribed message into a command from an actuator,
a controller triggering:
   a parameterization to the required value to a required actuator, and/or
   a provision of information, data to a determined device based on the required pieces of information, data, and/or
   an execution of a command by an actuator based on the required action instruction
an analyzer interpreting the responses provided either by the actuator, or including the required information or data and generating a response message based on the responses provided. The response message is in particular written in natural language.

In particular modes of implementation, the alert method further comprises a control (S530, S630) of an actuator by means of a command generated (S520, S623) based on at least one element among the following:
the detected alert situation;
at least one data acquired from at least one sensor;
at least one data provided by analysis of data acquired from at least one sensor;
at least one piece of information extracted, by voice recognition, from a voice message coming from a device among the following:
   the remote communication terminal with which the communication session is established;
   a local audio sensor connected to the communication device activated by the alert method.

Particularly, the alert method further comprises a generation of a command S520, S623 based on at least one element among the following:
the detected alert situation;
at least one data acquired from at least one sensor;
at least one data provided by analysis of data acquired from at least one sensor;
at least one piece of information extracted, by voice recognition, from a voice message coming from a device among the following:
   the remote communication terminal with which the communication session is established;
   a local audio sensor connected to the communication device activated by the alert method.

Thus, the command can be generated:
autonomously by the alert method based on the alert situation detected and on one or more data acquired from at least one sensor (for example, alert situation of the “fire” and “open” gas inlet type, the command will then be the closing of the gas inlet; or alert situation “fall down the stairs” and “locked” front door, the command will then be the unlocking of the front door or of another opening of the house: French window, window, etc.);
based on an instruction by voice message:
   from the first individual unable to move;
   from the interlocutor of the remote communication terminal;
   from a second individual present at the scene of the alert, possibly after authorization from the first individual or from the interlocutor of the remote communication terminal.

For example, a second voice message includes the instruction based on which the command is generated. The second voice message comes in particular from one among the following:
the remote communication terminal with which the communication session is established;
a local audio sensor connected to the communication device activated by the alert method.

Particularly, the alert method further comprises, following a second voice message coming from one among the following:
the remote communication terminal with which the communication session is established;
a local audio sensor connected to the communication device activated by the alert method.

A generation of a response message, also called third message, based on at least one data among at least the following data:
at least one data acquired from at least one sensor;
at least one data provided by analysis of data acquired from at least one sensor,
at least one piece of information extracted, by voice recognition, from the second voice message;
and the response message is able to be vocally synthesized and transmitted, upon establishment of the communication session, in the form of a voice message via the established communication session.

For example, when the second message requires additional data, the third message includes, for example, for at least one of the required data for which values have been acquired by the alert method, for example by consulting one or more memory(ies) and/or one or more sensor(s) and/or one or more actuator(s), a value of the required data.

Alternatively or complementarily, when the second message triggers a control of an actuator based on a command, the third message includes:
either simply an acknowledgement of implementation of the command by the actuator;
or, in a more complex manner, data acquired from the actuator and, possibly, other sensors following the execution of the command by the actuator.

Particularly, the alert method includes voice recognition able to extract information from a voice signal coming from one device among the following:
the second voice message from the remote communication terminal with which the communication session is established;
a voice signal from a local audio sensor activated by the alert method.

In particular modes of implementation, the alert communication device 100 permanently informs the interlocutor of the evolution of the situation. In this case, the alert method according to the disclosed technology comprises:
a transmission via the established communication session of a third voice message generated by voice synthesis based on the acquired data that have evolved, the transmission having been triggered by an evolution in a value of at least one data acquired towards a range of alert values.

Thus, if the device determines for example that the respiratory rate of the individual evolves from 16 to 10 cycles per minute, that is to say towards a range of alert respiratory rates (in this case less than 12 cycles per minute), the alert communication device 100 emits the following sentence “The respiratory rate of the individual is now 10 cycles per minute”.

Particularly, the alert method then includes one or more of the following steps:
a detection of an evolution of an acquired data;
a detection that an acquired data, particularly an acquired data that has evolved, has a value included in a range of alert values.

In particular modes of implementation, the alert communication device 100 determines (S500), autonomously, the action(s) to be performed given the alert situation. The alert method according to the disclosed technology then comprises:
a determination (S510), autonomously and based on the alert situation, of at least one action to be performed by an actuator connected to the alert communication device 100;
an acquisition (S520) of a command associated with said action that can be interpreted by this actuator; and,
the control (S530) of the actuator by means of this command.

In particular modes of implementation, the alert communication device 100 is configured to adapt (S600) the configuration of the environment of the individual in response to a verbal instruction received from the interlocutor of the emergency service. In this case, the method comprises:
the receipt (S610) of a voice instruction emitted by the interlocutor of the emergency service;
the conversion (S620) of the instruction received into a command interpretable by an actuator connected to the alert communication device 100; and,
the transmission (S630) of the command to this actuator.

In particular modes of implementation, the alert communication device 100 is configured to:
determine (S710) that a second individual is located in the vicinity of the first individual; and,
activate (S720) an audio sensor of said alert communication device 100.

Particularly, the presence of a second individual is detected by one of the sensors of the local area network 160, and the alert communication device 100 is then configured to activate the audio sensor of the alert communication device 100, in order to allow this second individual to communicate with the interlocutor of the emergency service.

The alert communication device 100 has so far been described as being a device in itself but it could also be integrated into a mobile phone and use the sensors of said phone to implement the disclosed technology.

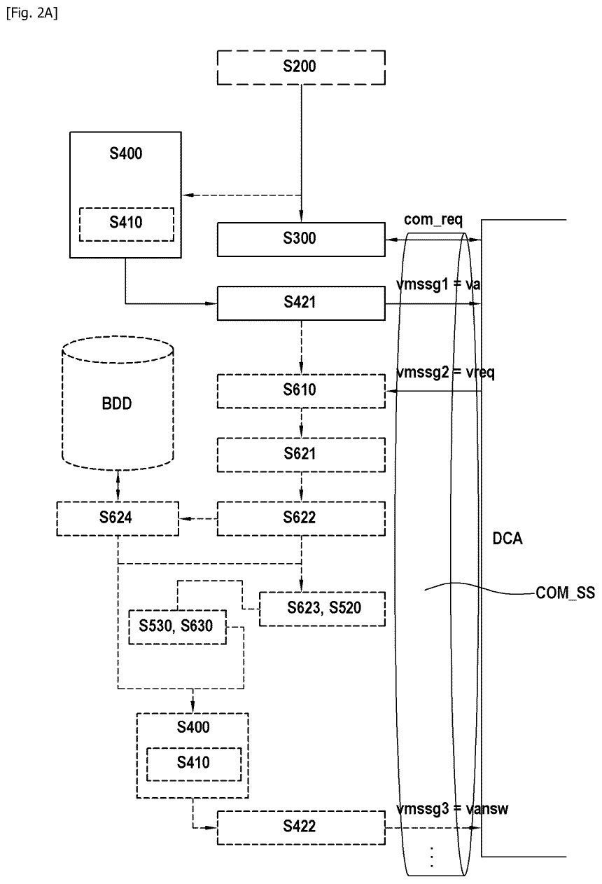

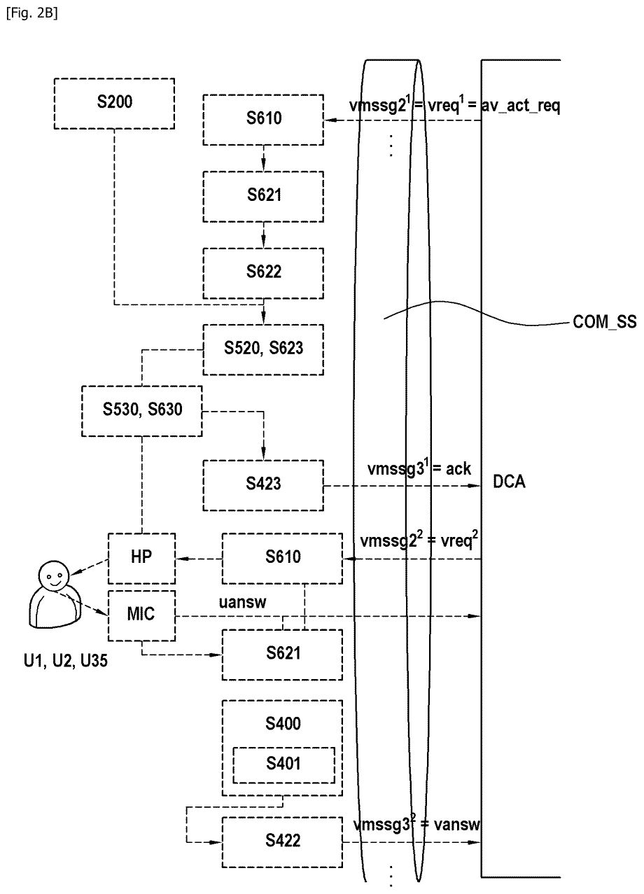

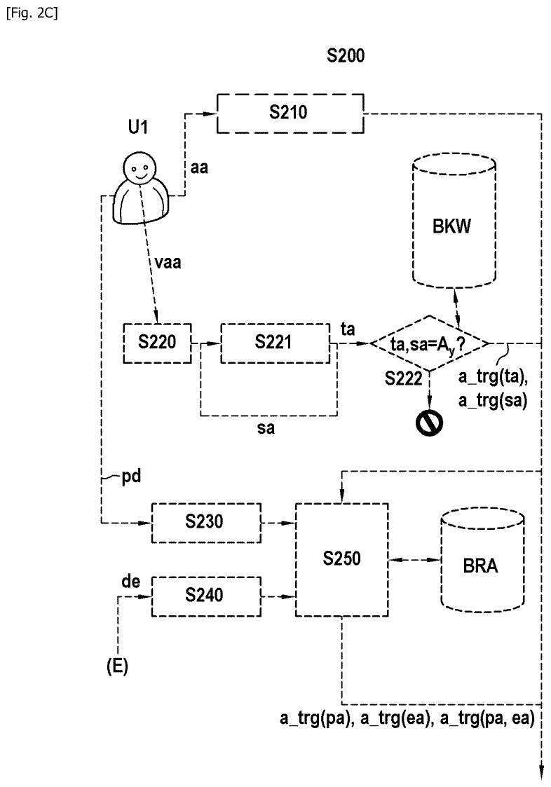

FIG. 2A represents, in the form of a simplified block diagram, one example of an alert method for a remote communication terminal proposing a more detailed mode of implementation relative to the establishment of the communication session and the transmission of the first message to the communication terminal.

Particularly, the alert method includes a detection of an alert situation S200.

Particularly, the alert method includes a message generation S400 able to generate a message based on data acquired from at least one sensor, in particular an alert message. Optionally, the message generation S400 includes a voice synthesis S410 converting the message generated based on the data acquired from at least one sensor into a voice message. The message generation S400 is optionally triggered by a detection of an alert situation S200, the message thus generated is then an alert message ma, va.

The alert method includes an establishment S300 of a communication session between the alert communication device implementing the alert method and a remote communication terminal DCA such as a communication terminal of an emergency service. In particular, the communication session establishment S300 comprises the exchange of a request to establish a communication session com_req with the remote communication terminal DCA, for example to this remote communication terminal, triggering the opening of the communication session COM_SS, possibly following an agreement com_ack (not illustrated) from the remote communication terminal DCA.

The thus open communication session SS_COM allows the alert communication device implementing the alert method and to the remote communication terminal DCA to exchange either written or voice messages based on the type of open communication session (text and/or voice chat, voice calls, video calls, etc.). Particularly, the establishment of the communication session S300 triggers (not illustrated) a generation S400 of an alert message based on data acquired from at least one sensor, in particular following the opening of the communication session COM_SS.

The alert method then includes an emission S421 of an alert message ma, va, also called first message mssg1, vmssg1, generated based to data acquired from at least one sensor.

Particularly, the alert method includes a receipt of a second message mssg2, possibly voice message vmssg2, from the remote communication terminal. The second message is in particular a request from the interlocutor of the remote communication terminal: mssg2=reqi, vmssg2=vreq1. In the particular case of a second voice message, the alert method includes a conversion S621 of the voice message into text. Then, the alert method possibly includes a determination S622 of the data and/or commands required in the second message.

Particularly, the alert method includes a consultation S624 of one or more database(s), consulting in particular a database BDD including personal and/or environmental data recorded prior to the implementation of the alert method (for example during the installation and/or initialization of the alert method) and/or acquired by one or more sensor(s) prior to their consultation, which makes it possible for example to consult a history of data acquired from at least one sensor over time ranges prior to the detection of the alert situation. The database is in particular implemented in the alert communication device or connected via a communication network to the alert communication device. The consultation S624 is in particular triggered based on the second message received S610 and/or on the alert situation detected and/or on the first message emitted S421 (thus the alert communication device can autonomously search for additional data based on the alert message emitted and/or on the alert situation detected while retaining a complete but succinct alert message allowing the interlocutor to quickly analyze the situation and quickly trigger either a second message or directly an external intervention).

Particularly, the alert method includes a control S530, S630 of actuators and/or sensors by means of a command based in particular on a second message coming from the remote communication terminal and/or from the alert situation detected and/or from the first message emitted (thus the alert communication device can autonomously control additional data based on the alert message emitted and/or on the alert situation detected).

Particularly, the alert method includes a generation S520, S623 of actuator and/or sensor commands based for example on a second message coming from the remote communication terminal and/or from the detected alert situation and/or from the first emitted message. In particular, a control S530, S630 of actuators and/or sensors, possibly implemented by the alert method, receives the command generated by the generation of commands S520, S623 implemented by the alert method.

An actuator is in particular a device controllable by another electronic device producing a physical phenomenon such as a lamp (in particular LED), a switch, a motor, an audio and/or image and/or video player (screen, LCD display, indicator light, speakers, etc.), a fan, a valve, a jack, a resistor, etc. A sensor is an electronic device detecting a physical phenomenon such as a push button; an audio sensor; a presence, smoke, leak, intrusion detector, etc.; a biometric sensor; etc.

Following a control of an actuator, respectively a sensor, by a command generated based on a second message coming from the remote communication terminal and/or from the detected alert situation and/or from the first emitted message, the controlled actuator, respectively sensor, provides at least one data such as a data of acceptance of the command and/or one or more data resulting from the implementation of the command by the actuator, respectively the sensor (in this case data acquired by the sensor by implementation of the command).

Particularly, the alert method includes a generation S400 of a response message, also called third message, either to a second message coming from the remote communication terminal or to the detected alert situation and/or to the first emitted message thus allowing the alert communication device to provide a message complementary to the alert message autonomously. The generation of a response message is in particular based on at least one data provided by a consultation S624 and/or by at least one controlled actuator, respectively at least one controlled sensor, based on a second message coming from the remote communication terminal such as a data of acceptance of the command and/or one or more data resulting from the implementation of the command by the actuator, respectively the sensor (in this case data acquired by the sensor by implementation of the command).

Optionally, the message generation S400 includes a voice synthesis S410 converting the response message generated based on the data acquired from at least one sensor into a voice message.

The response message generation S400 is optionally triggered by the provision of data by the consultation and/or by an actuator and/or a sensor, a control of an actuator and/or a sensor. In the case where the response message is generated following receipt of a second message coming from a remote communication terminal, the response message is generated when all or part of the data responding to the second messages have been provided.

Thus, when the data are provided at separate times, the message generation may include a generation of several response messages, the third message making it possible to send the responses as data are acquired from a consultation, and/or as data are provided by at least one actuator and/or at least one sensor. This avoids the delays in providing information to the interlocutor of the remote communication terminal and therefore the decision-making delays by this interlocutor. It should be noted that the remote communication terminal may be equipped with a decision aid device able to analyze the messages coming from any communication device (i.e. more generally from a communication terminal used by a human) connected to the remote communication terminal. The alert method generating response messages as data are provided will thus reduce the decision aid delay by the remote communication terminal.

The generation of the message when all the data responding to the second message have been provided makes it possible to ensure that all the requests from the interlocutor of the remote communication terminal will have been answered by the generated response message. This makes it possible to avoid decision errors due to a partial analysis of the situation by the interlocutor of the remote communication terminal, or even by the decision aid device of the remote communication terminal.

Particularly, the alert method then includes an emission S422 of a response message mansw, vansw, also called third message mssg3, vmssg3, generated based on data provided by a consultation, and/or a controlled actuator and/or sensor, based on either a second message coming from the remote communication terminal or from the detected alert situation and/or from the first emitted message.

FIG. 2B represents, in the form of a simplified block diagram, one example of an alert method for a remote communication terminal proposing a more detailed mode of implementation relative to a connection between the interlocutor of the remote communication terminal and at least one second individual on the alert site (in particular in the vicinity of a first individual).

FIG. 2B illustrates a particular case of FIG. 2A in which at least one audio sensor and/or at least one speaker is activated. The alert situation detection S200 has already established the communication session SS_COM and, possibly, emitted the alert message.

Particularly, the alert method includes the receipt of a second message mssg2¹, possibly voice message vmssg2¹, from the remote communication terminal. The second message is in particular a request, coming from the interlocutor of the remote communication terminal, to activate: mssg2¹, vmssg2¹=av_act_req an audio sensor such as a microphone or a microphone array, and/or a video sensor such as a camera, and/or at least one audio player such as at least one speaker or an audio playback system in particular a 3D sound player, etc. and/or one video player such as a screen or a hologram, etc. In the particular case of a second voice message, the alert method includes a conversion of the voice message into text S621. Then, the alert method optionally includes a determination of the data and/or commands required in the second message S622.

Particularly, the alert method includes a control of audio and/or video sensors, and/or audio and/or video players S530, S630 by means of an activation command based in particular on a second activation request message coming from the remote communication terminal and/or from the detected alert situation and/or from the first emitted message (thus the alert communication device can autonomously activate a microphone and/or a speaker based on the emitted alert message and/or on the detected alert situation). The microphone will in particular allow the interlocutor of the remote communication terminal to hear the sound of the environment in the alert situation: crackling, etc., particularly the sounds emitted by the first individual: coughing, wheezing, etc. The speaker, even if it does not allow dialogue with the first individual in some situations—choking for example—will allow the interlocutor of the remote communication terminal to reassure them. Furthermore, the activation of a microphone and of a speaker by the alert method makes it possible to establish a dialogue between the first individual and the interlocutor of the remote communication terminal when the first individual is not able to approach the alert communication device.

Particularly, the alert method includes a generation of commands for activating sensors and/or audio and/or video players S520, S623 based for example on a second activation request message coming from the remote communication terminal and/or from the detected alert situation and/or from the first emitted message. In particular, a control of the activation of sensors and/or audio and/or video players, possibly S530, S630 implemented by the alert method, receives the command generated by the activation command generation S520, S623 implemented by the alert method.

Following an activation control of an audio and/or video player, respectively an audio and/or video sensor, by an activation command generated based on a second activation request message coming from the remote communication terminal and/or from the detected alert situation and/or from the first emitted message, the controlled audio and/or video player, respectively audio and/or video sensor, provides at least one data such as data of acceptance of the command and/or one or more data resulting from the implementation of the command by the audio and/or video player, respectively the audio and/or video sensor (in this case data acquired by the sensor by implementation of the command).

Particularly, the alert method includes an emission S423 of an activation message ack indicating that the sensor(s) and/or the audio and/or video player(s) is/are activated, also called third message mssg3¹, vmssg3¹=ack, generated following the activation of controlled sensors and/or audio and/or video players, based on either a second activation request message coming from the remote communication terminal or on the detected alert situation and/or on the first emitted message.

Then, the alert method may include a receipt of a new second message mssg2², possibly vocal message vmssg2², from the communication terminal remote from the activation request message mssg2¹. This new second message mssg2², vmssg2² is in particular a request from the interlocutor of the remote communication terminal. Particularly, when an audio and/or video player has been previously activated, the new second message received is played back by this player (message written on a video/image player, voice message by an audio player).

The steps implemented by the alert method following the receipt of this new second message mssg2², vmssg2² are in particular those described in relation to FIG. 2A upon receipt of a second message mssg2, vmssg2 including, particularly:
a generation of a new response message S400, also called new third message mssg3², vssmg3², to the new second message mssg2², vmssg2² coming from the remote communication terminal. The generation of this new response message is in particular based on at least one data provided by a consultation S624 and/or by at least one actuator, respectively at least one sensor, the data acquired by the at least one activated audio and/or video sensor, controlled based on a new second message coming from the remote communication terminal such as a data of acceptance of the command and/or one or more data resulting from the implementation of the command by the actuator, respectively the sensor (in this case data acquired by the sensor by implementation of the command).

Optionally, the message generation S400 includes a voice synthesis S410 converting the response message generated based on the data acquired from at least one sensor into voice message.

The response message generation S400 is optionally triggered by the provision of data by the consultation and/or by an actuator and/or a sensor, a control of an actuator and/or a sensor. In the case where the response message is generated following a receipt of a second message coming from a remote communication terminal, the response message is generated when all or part of the data responding to the second messages have been provided.

Particularly, the alert method then includes an emission S422 of a new response message mansw, vansw, also called a new third message mssg3₂, vmssg3₂, generated based on data provided by a consultation, and/or a controlled actuator and/or sensor, based on a new second message coming from the remote communication terminal.

Thus, the alert method can process several second messages and emit several third messages in return.

FIG. 2C represents, in the form of a simplified block diagram, one example of alert situation detection S200 used and/or implemented by the alert method for a remote communication terminal.

Particularly, the alert detection includes an activation S210 of an alert button by the first individual U1 following in particular an alert action aa, for example pressing this alert button. The alert activation then triggers a_trg the detection of the alert.

Particularly, the alert detection includes a sound capture S220 of a voice signal coming from the first individual U1. In order to determine whether the voice signal vaa is a voice alert, the alert detection in particular includes a verification of the content of the voice signal vaa able to determine whether the content of the voice signal vaa includes a voice alert. When it is determined that the voice signal does not include an alert, the alert method is stopped S223 and the alert detection is reset. When it is determined that the voice signal includes an alert then the verification S222 triggers a detection of the alert a_trg(ta), a_trg(sa), a_trg(vaa) . . . possibly including the text and/or sound and/or voice alert signal and/or any other element that has been used during the verification S222.

For example, the alert detection includes a voice recognition S221 of the content of the voice signal vaa by textualizing the captured voice signal; then, the alert detection checks S222 whether the recognized text signal ta includes an alert. The verification S222 of the content of the voice signal or sound signal (non-voice sound extraction of the captured sound signal) or text signal is performed in particular by comparison of the content of the signal with a base of audio and/or text alert signals BKW, in particular expressions, keywords, alert sounds {Ay}y, for example by comparison of the signal with the elements of the base of alert signals ta, sa=Ay?.

Particularly, the alert detection includes a situation analysis S250 based on captured data. The captured data are in particular personal data pd of the first individual U1 and/or environmental data of the environment E of the first individual U1. The situation analysis is performed in particular by using an alert rule base BRA and/or by a neural and/or artificial intelligence network, etc. The situation analysis S250 then triggers an alert detection based on the personal data a_trg(pa), on environmental data a_trg(ea), or both a_trg(pa, ea) by possibly transmitting the data that allowed the analysis for the detection of the alert situation.

In particular, the alert detection includes, prior to the situation analysis S250, a data capture S230, S240, in particular at least one capture among the following:
a capture of personal data S230;
a capture of environmental data S240.

It should be noted that the optional steps of the alert method of FIGS. 2A, 2B and 2C may be implemented by the alert method itself or one or more method(s) distinct from the alert method possibly implemented by the alert communication device.

FIG. 3 schematically represents one exemplary mode of implementation, in accordance with the disclosed technology, of an alert communication device able to communicate with an emergency service.

FIG. 4 schematically represents exemplary hardware architecture of an alert communication device able to communicate with an emergency service.

As illustrated in FIG. 4, the alert communication device 100 has the hardware architecture of a computer. Thus, the device includes, in particular, a processor 1, a random access memory 2, a read-only memory 3 and a non-volatile memory 4. It further includes a communication interface 5.

The read-only memory 3 of the system constitutes a recording medium as proposed, readable by the processor 1 and on which a computer program PROG in accordance with the disclosed technology is recorded, including instructions for the execution of steps of the alert method as proposed. The program PROG defines functional modules of the device 100 as represented in FIG. 3, which rely on or control the hardware elements 1 to 5 of the alert communication device cited above, and which comprise in particular:
a module (MOD_OBT) for acquiring data, in particular health data of a first individual and/or data relating to the environment of the first individual, said data being captured by at least one sensor connected to said device;
an alert situation detector (MOD_DET) able in particular to detect that the first individual is in an alert situation, by analysis of the data acquired from at least one sensor;
an interface (MOD_COM) for communicating said device with a remote communication terminal, in particular an emergency service;
a voice signal operator (MOD_TX) including a voice synthesizer of the data derived from said analysis. The voice signal operator is a device able to process voice signals by performing in particular a series of operations on a voice signal or providing a voice signal. One example of a voice signal operator is a voice signal processor, a voice signal processing electronic card, etc. Thus, the alert communication device is able to dialog with a human interlocutor of the remote communication terminal, without requiring the establishment of the communication with a remote communication terminal able to manage a “machine” caller.

Particularly, the communication interface includes a communication device able to establish a communication session. The communication interface and/or, where appropriate, the communication device, includes a message emitter able to emit a message via the communication session established by the communication interface and, optionally, a receiver able to receive a message via the communication session established by the communication interface.

Particularly, the acquisition module includes at least one device among the following:

one or more sensor(s);

one or more receiver(s) able to receive data captured by one or more sensor(s) connected to the alert communication device via one or more distinct communication network(s) (Bluetooth, Wi-Fi, Ethernet, CPL; mobile communication network: 4G, 5G, etc.).

Moreover, the alert communication device (100) may further include other functional modules or sub-devices, in particular able to implement particular modes of the alert method, as described in more detail later.

It should be particularly noted that the voice signal operator MOD_TX comprises:
a natural language message analyzer, also called natural language understanding analyzer, is configured in particular to understand the meaning of text data;
a natural language generator is configured in particular to produce a text message in natural language from data acquired from at least one sensor, and this text message in natural language will be possibly converted into a voice message in natural language by the voice synthesizer;
a voice recognition operator, also called automatic speech recognition operator, configured to analyze audio content, in particular a voice message, and transcribe it into text content, in particular a text message. The voice recognition operator is a device able to process voice signals by performing in particular a series of operations providing a voice signal. One example of a voice recognition operator is a voice recognition processor, a voice recognition electronic card, etc. Particularly, the text message includes at least one piece of information extracted from the voice signal exploitable by the alert communication device. Particularly, the alert communication device triggers, based on the information extracted from the voice signal by voice recognition, either the acquisition of additional required data (included in the extracted information), or the control of an actuator based on a command generated based on the extracted information, etc.

It should also be noted that in particular modes of implementation, the alert communication device 100 relies on an inference engine to determine the response to be given to a question from an interlocutor. According to a first example, this inference engine is a rule engine comprising a set of inference rules and axioms, for example in accordance with the modal logic, for example with an epistemic modal logic which makes it possible to reason about the knowledge of both the agent and also to propose supposed knowledge of the other agents, such as for example the interlocutor of the emergency center. This set of rules and axioms can be regularly updated, for example by using machine learning mechanisms, or by receiving update data coming from a manager of the alert communication device 100.

According to a second example, this inference engine implements an “artificial intelligence”, and is for example based on a machine learning model such as an artificial neural network.

According to a third example, this inference engine uses a planning engine of the PDDL (Planning Domain Definition Language) type.

Moreover, the inference engine possibly includes one or more of the following devices:
an analyzer interpreting the transcribed message,
an action instruction analyzer interpreting the action instruction interpreted from the transcribed message into a command of an actuator,
a controller triggering:
   a parameterization to the required value to a required actuator, and/or
   a provision of information, data to a determined device based on the required information, data, and/or
   an execution of a command by an actuator based on the required action instruction,
an analyzer interpreting the responses either provided by the actuator or including the required information or data and generating a response message based on the responses provided. The response message is in particular written in natural language.

It should also be noted that in particular modes of implementation, the alert communication device 100 comprises:
audio sensors, such as an audio sensor, in order to capture the sound environment of the alert communication device 100; and/or
audio rendering means, such as a speaker, in order to be able to broadcast an audio message in the environment of said alert communication device 100. The audio rendering means make it possible in particular to broadcast, in the environment of the alert communication device 100, a message received from the emergency service interlocutor so that it can be heard by the individual in an alert situation.

The communication interface 5 in particular allows the alert communication device 100 to communicate with a telecommunications network 200, and with the electronic devices (actuators and/or sensors). To do so, the communication interface 5 includes a wired or non-wired communication interface able to implement any protocol supported by the telecommunications network 200.

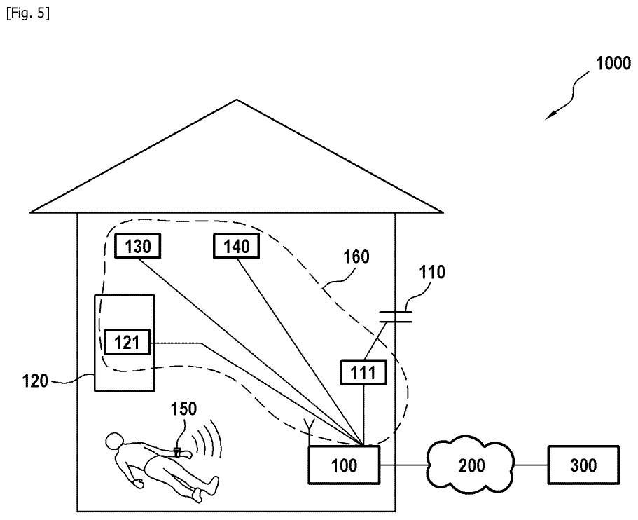

FIG. 5 schematically represents a first exemplary mode of implementation in accordance with the disclosed technology, of a system 1000 comprising an alert communication device 100 able to communicate with an emergency service.

As illustrated in FIG. 5, the system 1000 comprises an alert communication device 100, here installed within a home, and connected through a wired or non-wired connection to a local area network 160 comprising a plurality of electronic devices. These electronic devices may for example comprise an actuator 111 controlling a gas inlet 110, an actuator 121 controlling the opening and closing of a front door 120, a presence detector 130 configured to detect movement or the infrared radiation emitted by a human body, a smoke and/or gas detector 140, as well as a connected watch 150. This connected watch 150 is configured to record the physiological data of an individual such as their blood pressure, respiratory rate, heart rate and/or temperature, and transmit them regularly to the alert communication device 100. This connected watch 150 is also configured to transmit, at regular intervals, the position of the individual to the alert communication device 100.

The alert communication device 100 is also connected to an emergency service 300 through a telecommunications network 200 such as the Internet or a mobile telephone network, for example, on the basis of any one of the technologies 2G (GSM) to 4G+(LTE Advanced), 5G or even VHF. Particularly, the 5G Ultra-Reliable Low Latency Communications technology provides advantageous reliability in case of an alert situation.

The device 100 is configured to analyze the data it receives from the various sensors, here the data captured by the presence detector 130, the smoke and/or gas detector 140, and the connected watch 150.

The scenario in which a fire breaks out in the home is now considered. The smoke and/or gas detector triggers an audible alarm, and transmits a smoke and/or gas detection signal to the alert communication device 100. Thanks to the positioning data transmitted by the connected watch 150 and/or to the data transmitted by the presence detector 130, the device 100 determines that an individual is present in the home, but that the latter is immobile.

The device 100 then determines that the individual is in an alert situation, since they risk being poisoned by the fumes at any time. The device 100 then communicates with an emergency service 300 such as the fire department, by calling 18 or 112. The interlocutor (e.g., a firefighter) from the emergency service, who is not aware of the fact that it is an alert communication device 100 that generated the call, then asks the reason for the call. The alert communication device 100 responds to the interlocutor that a fire has been detected, by emitting a response message generated by voice synthesis. The interlocutor then asks if people are in danger, and the alert communication device 100 analyzes the question and then responds in the affirmative by emitting a new response message by voice synthesis.

The interlocutor then asks the alert communication device 100 to secure the premises and to facilitate access to the emergency services. In response to receiving this voice instruction, the alert communication device 100:
determines that the gas inlet shutoff valve 110 must be closed;
converts this action into a command interpretable by the actuator 111; and,
transmits a command to close the gas inlet shutoff valve 110.

In parallel, the alert communication device 100 transmits an unlocking command to the actuator 121 of the front door 120.

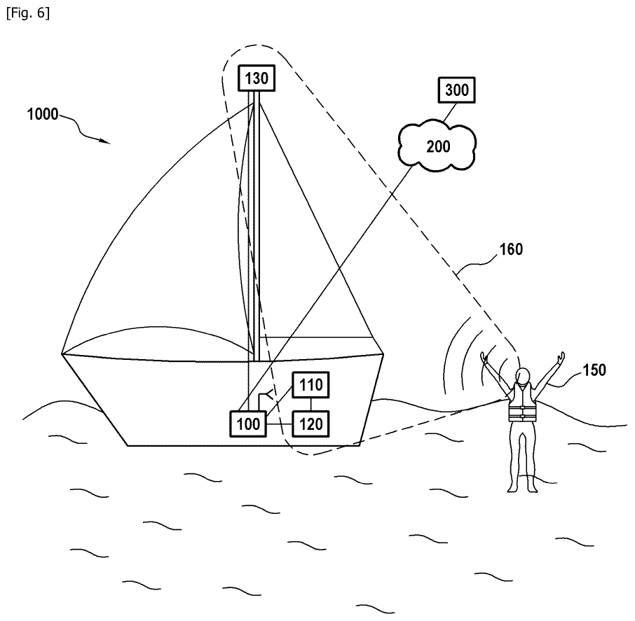

FIG. 6 schematically represents a second exemplary mode of implementation in accordance with the disclosed technology, of a system comprising an alert communication device able to communicate with an emergency service.

As illustrated in FIG. 6, the system 1000 comprises an alert communication device 100, here embedded in a sailboat, and connected through a wired or non-wired connection to a local area network 160 comprising a plurality of electronic devices. These electronic devices may for example comprise an autopilot 120 (controlling an actuator able to act on the rudder of the sailboat according to a given instruction that may correspond to a heading or a speed), a navigation assistant (Global Positioning System) 110, an anemometer 130 and a connected life jacket 150.

The alert communication device 100 is also able to contact an emergency service 300 such as a Regional Operating Surveillance and Rescue Center (French acronym CROSS), through a telecommunications network 200 corresponding to a mobile phone network, a radio network in the high frequency (Very High Frequency or Medium High Frequency) band, or a satellite transmission network (e.g., INMARSAT, COPSAS-SARSAT).

This radio equipment may be associated with a “Digital Selective Calling” device. The system 1000 may also comprise an automatic identification system, or AIS receiver, in order to be able to know all the vessels located in the vicinity of said sailboat (e.g., 15-20 nautical miles away) and equipped with an AIS emitter, but also a VHF equipment.

The scenario according to which, during a maneuver, the helmsman who was alone on board the sailboat falls into the water is now considered. In response to the detection of a fall into the water, the connected life jacket 150 transmits a distress signal to the alert communication device 100.

In response to receiving such a signal, the alert communication device 100 determines that the individual is in an alert situation, and transmits commands to the autopilot 120 so that the sailboat adapts its trajectory and speed. More specifically, by taking into account the wind direction provided by the anemometer and the geographic position that the sailboat had when the connected lifejacket 150 has emitted the distress signal, the alert communication device 100 provides heading instructions to the autopilot 120, so that the sailboat approaches the person in the water.

In parallel, the alert communication device 100 connects to the channel 16 of the VHF marine band, then emits a distress message by voice synthesis that comprises the following indications: “mayday mayday mayday; name of the sailboat repeated three times; geographic coordinates of the sailboat; cause of the call”.

The distress signal is intercepted by an interlocutor (e.g., military personnel of the French Navy) of the CROSS who is not aware of the fact that it is an alert communication device that generated the call, and who then asks for details.

The alert communication device 100 emits a response message by voice synthesis, and responds to the interlocutor that the helmsman has fallen into the water and that a man overboard maneuver is in progress.

The particular modes of implementation described in relation to the figures can be implemented alone or in combination with one or more other particular modes of implementation(s) described.

Although the present disclosure has been described with reference to one or more examples, workers skilled in the art will recognize that changes may be made in form and detail without departing from the scope of the disclosure and/or the appended claims.

1. An alert method for a remote communication terminal, the alert method being implemented by an alert communication device and comprising:
establishing a communication session between said alert communication device and a remote communication terminal triggered by a detection of an alert situation; and,
transmitting, via the established communication session, a generated message.

2. The alert method according to claim 1, wherein the establishment of the communication session is triggered by the detection of the alert situation based on data acquired from at least one sensor.

3. The alert method according to claim 1, wherein the message is generated based on the detected alert situation and on data acquired from at least one sensor.

4. The alert method according to claim 1, wherein the transmitted message is a voice message generated by voice synthesis based on data acquired from at least one sensor.

5. The alert method according to claim 1, further comprising:
acquiring data from at least one sensor, the acquired data being at least one data among the following:
data relating to a first individual;
data relating to an environment;
data relating to an environment of a first individual;
data captured by at least one sensor connected to the alert communication device;
data captured by at least one sensor of the alert communication device;
sound data including at least one sound signal captured by at least one sensor connected to the alert communication device;
sound data including at least one sound signal captured by at least one sensor of the alert communication device.

6. The alert method according to claim 1, further comprising detecting the alert situation by analysis of data acquired from at least one sensor, the detecting triggering the establishment of the communication session if the alert situation is detected.

7. The alert method according to claim 1, wherein the detection of an alert situation is performed by analysis of sound data acquired from at least one sensor.

8. The alert method according to claim 1, further comprising calculating a value representative of a probability that an individual is unable to contact an emergency service,
the establishment of a communication session being implemented in response to said value being greater than a threshold value.

9. The alert method according to claim 1, further comprising determining the remote communication terminal based on the detected alert situation.

10. The alert method according to claim 1, further comprising generating an alert message, called a “first message”, based on at least one data among at least the following data:
at least one data acquired from at least one sensor;
at least one data provided by analysis of data acquired from at least one sensor,
the alert message being able to be vocally synthesized and transmitted, upon establishment of the communication session, in the form of a voice message via the established communication session.

11. The alert method according to claim 1, further comprising activating an audio sensor, the audio sensor being an audio sensor among the following:
an audio sensor of said alert communication device;
an audio sensor connected to the alert communication device;
the activation being triggered based on at least one data among the following:
at least one data acquired from at least one sensor;
at least one data provided by analysis of data acquired from at least one sensor;
at least one piece of information extracted, by voice recognition, from a second voice message coming from the remote communication terminal with which the communication session is established.

12. The alert method according to claim 1, further comprising a voice synthesis of a message comprising at least one piece of information among the following:
at least one data acquired from at least one sensor;
at least one data provided by analysis of data acquired from at least one sensor;
at least one piece of information extracted, by voice recognition, from a voice signal coming from a device, the voice signal being one among the following:
a second voice message coming from the remote communication terminal with which the communication session is established;
a voice signal from a local audio sensor activated by the alert method;
at least one alert message, called a “first message”, generated based on one piece of information among the previous ones;
at least one response message, called a “third message”, generated based on one piece of information among the previous ones, the response message resulting from the second voice message coming from the remote communication terminal.

13. The alert method according to claim 1, further comprising performing a voice recognition extracting information from a voice signal coming from a device, the voice signal being one among the following:
a second voice message coming from the remote communication terminal with which the communication session is established;
a voice signal from a local audio sensor activated by the alert method.

14. The alert_method according to claim 1, further comprising controlling an actuator by using a command generated based on at least one element among the following:
an alert situation detected;
at least one data acquired from at least one sensor;
at least one data provided by analysis of data acquired from at least one sensor;
at least one piece of information extracted, by voice recognition, from a second voice message coming from one device among the following:
the remote communication terminal with which the communication session is established;
an audio sensor connected to the alert communication device and activated by the alert method.

15. (canceled)

16. An alert communication device comprising a processor, said alert communication device configured to:
establish a communication session between said communication device and a remote communication terminal as soon as an alert situation is detected, and
transmit, via the established communication session, a first voice message generated by voice synthesis.

17. A communication terminal comprising a processor, said communication terminal configured to:
establish a communication session between said communication device and a remote communication terminal as soon as an alert situation is detected, and
transmit via the established communication session a first voice message generated by voice synthesis.
